(19) United States
(12) Patent Application Publication
(10) Pub. No.: US 2011/0249456 A1
(43) Pub. Date: Oct. 13, 2011

(54) STRUCTURE OF LAMP SUPPORT

(76) Inventor: Chao-chin Yao, Taichung City (TW)

(21) Appl. No.: 12/758,021

(22) Filed: Apr. 11, 2010

(51) Int. Cl. F21V 21/08

(52) U.S. Cl. 362/396

(57) ABSTRACT

One end of a lamp support is defined as a mounting end, and the other end is defined as a connecting end. The mounting end connects to a lamp box, and the connecting end connects to a lamp base. The mounting end of the lamp support has a through hole. The tip of the mounting end is bent to form a hook section. The lamp box has a mounting hole and a groove in a shape corresponding to the hook section. An inserting element is inserted into the through hole of the mounting end and the mounting hole of the lamp box, thereby mounting the lamp support onto the lamp box. The hook section of the mounting end correspondingly catches the groove of the lamp box, fixing the lamp support.

### BACKGROUND OF THE INVENTION

1. Field of Invention

The invention relates to a lamp box structure and, in particular, to an improved structure of a lamp support.

2. Related Art

The assembly of conventional lamp support and lamp box is shown in FIG. 4. The lamp box 91 is protruded with a screw pipe 92. One end of the lamp support 93 has a mounting hole 94. The other end is formed with a through hole 96 for a lamp base 95. The lamp support 93 is mounted around the screw pipe 92 via the mounting hole 94. A nut 97 then locks on the screw pipe 92, urging the end of the lamp support 93 with the mounting hole 94. The lamp support 93 is thus positioned.

After some time of use, the lamp support 93 in the above-mentioned structure may wiggle due to the gravity effect or that the nut 97 becomes loose.

### SUMMARY OF THE INVENTION

An objective of the invention is to provide an improved structure of a lamp support that can effectively position the lamp support and prevent it from wiggling.

To achieve the above objective, the disclosed improved structure of a lamp support defines one end of the lamp support as a mounting end and the other end as a connecting end. The mounting end connects to a lamp box, and the connecting end connects to a lamp base. The invention is further characterized in that the mounting end of the lamp support has a through hole. The tip of the mounting end is bent to form a hook section. The lamp box has a mounting hole and a groove in a shape corresponding to the hook section. An inserting element is inserted into the through hole of the mounting end and the mounting hole of the lamp box, thereby mounting the lamp support onto the lamp box. The hook section of the mounting end correspondingly catches the groove of the lamp box, fixing the lamp support.

### BRIEF DESCRIPTION OF THE DRAWINGS

These and other features, aspects and advantages of the invention will become apparent by reference to the following description and accompanying drawings which are given by way of illustration only, and thus are not limitative of the invention, and wherein:

FIG. 1 is a three-dimensional exploded view of the invention;

FIG. 2 is a three-dimensional view of the invention after assembly;

FIG. 3 is a cross-sectional view of the invention after assembly; and

FIG. 4 is a schematic view of conventional lamp support and lamp box after assembly.

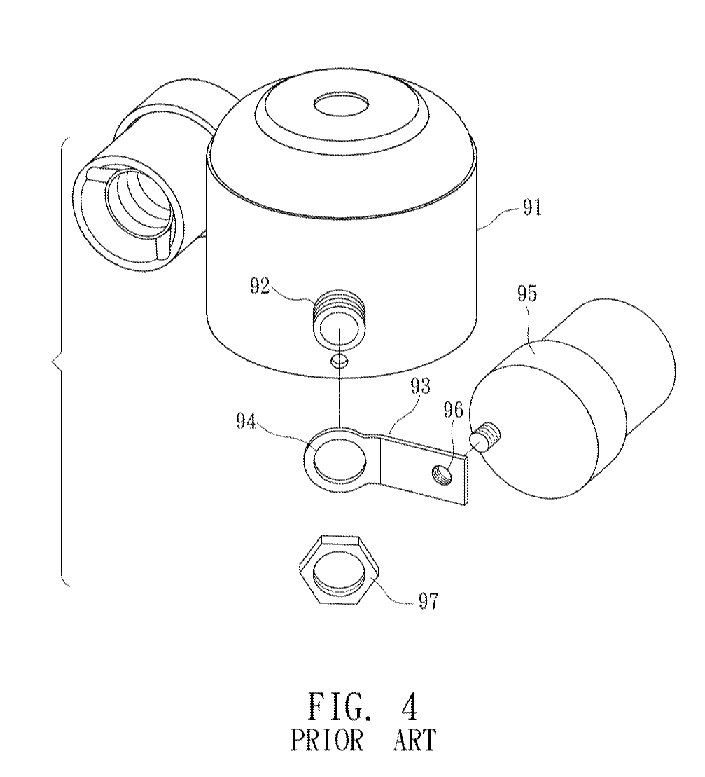

### DETAILED DESCRIPTION OF TILE INVENTION

The present invention will be apparent from the following detailed description, which proceeds with reference to the accompanying drawings, wherein the same references relate to the same elements.

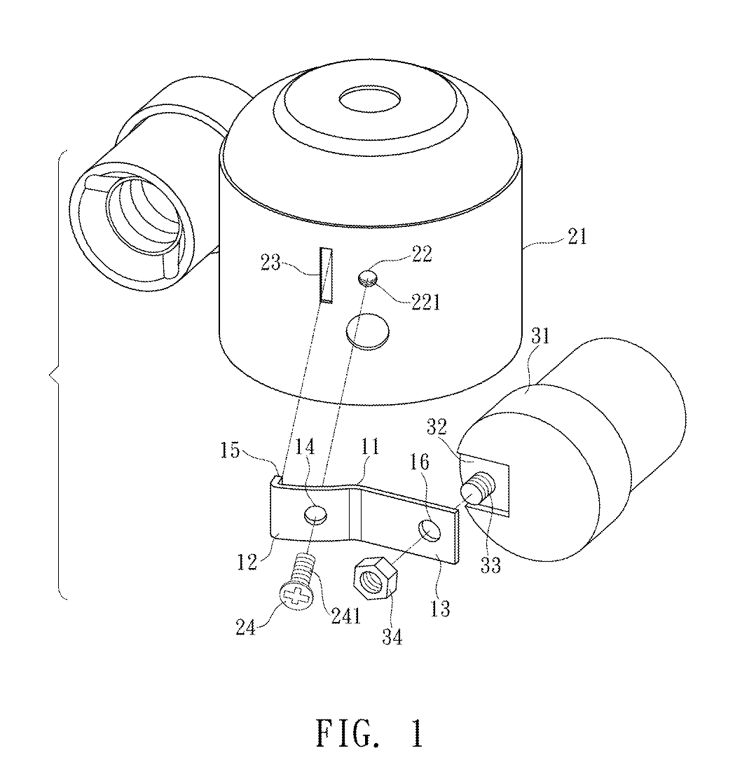

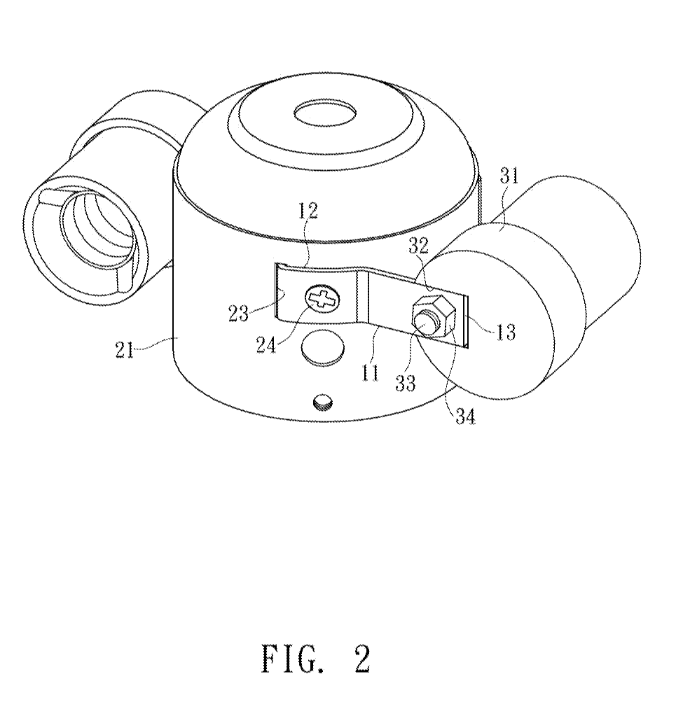

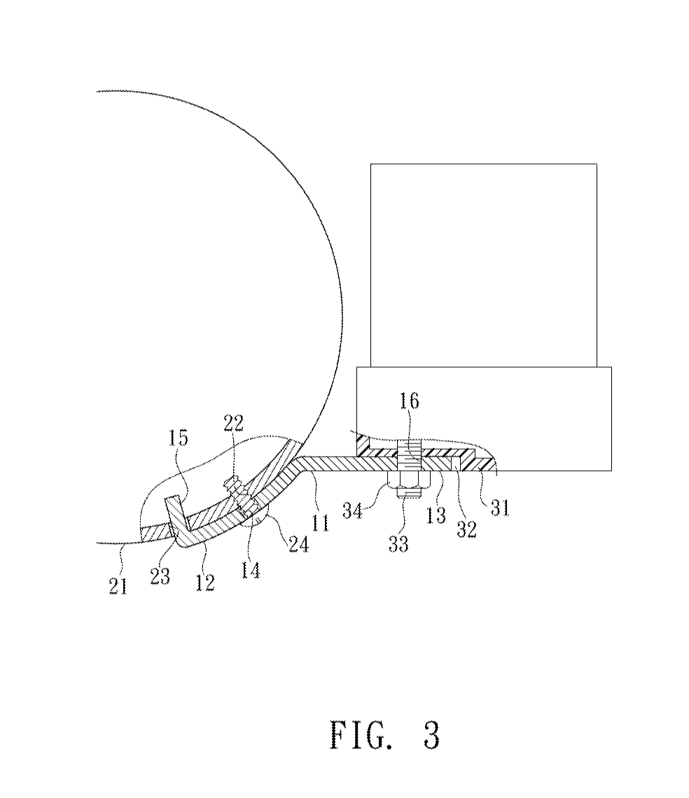

Please refer to FIGS. 1 to 3 for the improved structure of a lamp support. One end of the lamp support 11 is defined as a mounting end 12. The other end is defined as a connecting end 13. The mounting end 12 connects to a lamp box 21. The connecting end 13 connects to a lamp base 31.

The mounting end 12 of the lamp support 11 is formed with a through hole. The tip of the connecting end 12 is further bent to form a hook section 15.

The surrounding surface of the lamp box 21 for the connection with the mounting end 12 of the lamp support 11 is formed with a mounting hole 22 with an inner thread section 221 and a groove 23 in a shape corresponding to the hook section 15. An inserting element 24 has an outer thread section 241 corresponding, to the inner thread section 221 of the mounting hole 22. Therefore, the inserting element 24 can be inserted into the through hole 14 of the mounting end 12, and lock onto the mounting hole 22 of the lamp box 21. As the inserting element 24 urges against the mounting end 12 of the lamp support 11, the lamp support 11 and the lamp box 21 are connected. At the same time, the hook section 15 of the mounting end 12 catches the groove 23 of the lamp box 21. The lamp support 11 mounted on the lamp box 21 is restricted by the engagement of the hook section 15 and the groove 23 to be free from wiggling. The lamp support 11 is thus firmly positioned.

In this embodiment, the connecting end 13 of the lamp support 11 is formed with a connecting hole 16. The end surface of the lamp base 31 in connection with the connecting end 13 of the lamp support 11 is formed with a recess 32 in a shape corresponding to the connecting end 13. The recess 32 is protruded with a screw pin 33 corresponding to the connecting hole 16 of the connecting end 13. The connecting end 13 of the lamp support 11 is disposed on the screw pin 33 of the lamp base 31 via its connecting hole 16, and confined in the recess 32. A nut 34 then locks on the screw pin 33 and urges against the connecting end 13 of the lamp support 11. The lamp base 31 is positioned on the connecting end 13 of the lamp support 11. The recess 32 achieves the effect of blocking and restricting the connecting end 13. The lamp base 31 is thus firmly positioned and free from wiggling.

The invention has the following advantages:

1. The hook section 15 of the mounting end 12 of the lamp support 11 engages the groove 23 of the lamp box 21. An inserting element 24 is used to accomplish the assembly by going through the lamp support 11 and the lamp box 21. It is therefore comparatively easy to assemble or replace.

2. As the hook section 15 of the mounting end 12 of the lamp support 11 engages the groove 23 of the lamp box 21, the hook section 15 is blocked and restricted by the groove 23 so that the lamp support 11 does not wiggle. The lamp support 11 is thus firmly positioned.

3. The end surface of the lamp support 31 is formed with a recess 32 in a shape corresponding to the connecting end 13 of the lamp support 11. The connecting end 13 of the lamp support 11 is thus confined in the recess 32 of the lamp base 31. This also helps fixing the lamp base 31.

Although the invention has been described with reference to specific embodiments, this description is not meant to be construed in a limiting sense. Various modifications of the disclosed embodiments, as well as alternative embodiments, will be apparent to people skilled in the art. Therefore, it is contemplated that the appended claims will cover all modifications that fall within the true scope of the invention.

What is claimed is:

1. An improved structure of a lamp support with one end defined as a mounting end connecting to a lamp box and the other end defined as a connecting end connecting to a lamp base, characterized in that:
the mounting end of the lamp support is formed with a through hole; the tip of the mounting end is bent to form a hook section, the lamp box is formed with a mounting hole and a groove in a shape corresponding to the hook section; an inserting element is inserted via the through hole of the mounting end into the mounting hole of the lamp box, thereby mounting the lamp support on the lamp box; and the hook section of the mounting end catches the groove of the lamp box to confine the lamp support.

2. The improved structure of a lamp support as in claim 1, wherein the mounting hole has an inner thread section and the inserting element has an outer thread section corresponding to the inner thread section of the mounting hole; and the insetting element is inserted via the through hole of the mounting end and locks onto the mounting hole of the lamp box, urging the mounting end of the lamp support.

3. The improved structure of a lamp support as in claim 1, wherein the end surface of the lamp base is formed with a recess in a shape corresponding to the connecting end of the lamp support; and the connecting end of the lamp support is confined in the recess of the lamp base.

4. The improved structure of a lamp support as in claim 1, wherein the connecting end of the lamp support is formed with a connecting hole; the recess is protruded with a screw pin corresponding to the connecting hole of the connecting end; the connecting end of the lamp support is disposed in the recess of the lamp base by mounting the connecting hole on the screw pin of the lamp base; and a nut locks onto the screw pin and urges against the connecting end to position the lamp base.
